(19) United States
(12) Patent Application Publication
(10) Pub. No.: US 2013/0089205 A1
(43) Pub. Date: Apr. 11, 2013

(54) Token Provisioning Method

(71) Applicant: Helen Meng Pai, Taipei City (TW)

(72) Inventor: Helen Meng Pai, Taipei City (TW)

(73) Assignee: F2Ware, Inc., San Jose, CA (US)

(21) Appl. No.: 13/267,910

(22) Filed: Oct. 7, 2011

(51) Int. Cl. H04L 9/08; H04L 9/00

(52) U.S. Cl. 380/278; 380/44

(57) ABSTRACT

The present invention discloses a token provisioning method for a token provisioning system. The token provisioning method includes steps of generating at least one encryption key at a customer side; generating a plurality of seed numbers corresponding to a plurality of electronic serial numbers (ESNs) at the customer side, respectively; encrypting the plurality of seed numbers and the plurality of corresponding ESNs with the at least one encryption key at the customer side; decrypting the plurality of seed numbers and the plurality of corresponding ESNs with the at least one encryption key; and programming a plurality of tokens with the plurality of seed numbers and the plurality of corresponding ESNs.

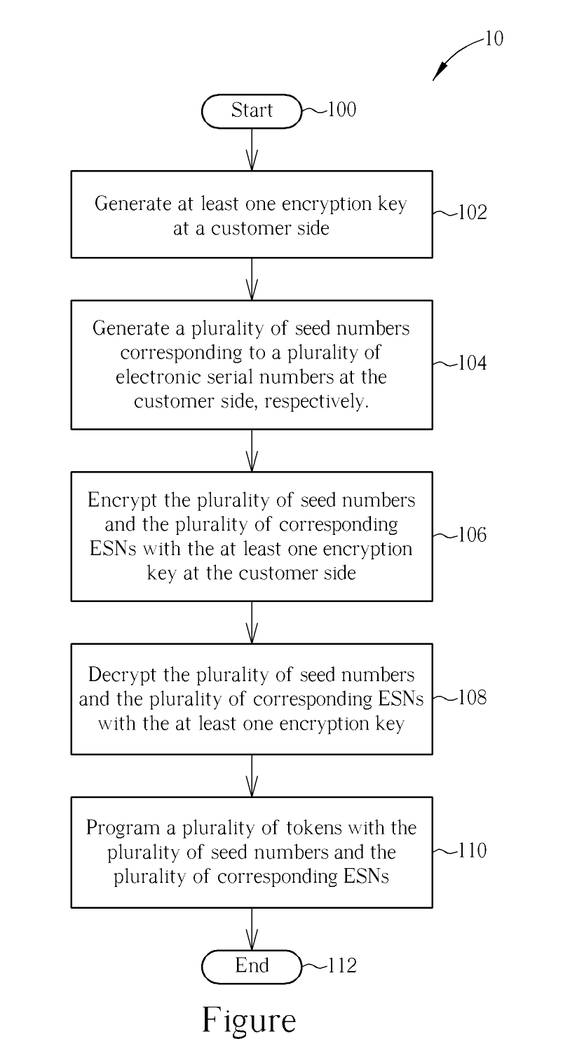

### BACKGROUND OF THE INVENTION

1. Field of the Invention

The present invention relates to a token provisioning method, and more particularly, to a token provisioning method for a token provisioning system capable of generating electronic serial numbers (ESNs) and corresponding seed numbers of tokens at the customer side, and storing them only in a database of the customer, to enhance security.

2. Description of the Prior Art

Incidents in which a company or government agency's security is breached, leading to a loss of information, personal records, or other data are an almost daily occurrence.

Even the servers of a well known security company have been breached compromising sensitive information from more than 40 million employees.

The information at risk, in the proceeding example, is the two-factor authentication tokens used by employees to access corporate and government networks.

Conventionally, a token provider assigns of electronic serial numbers (ESNs) and generates corresponding random seed numbers for tokens, respectively, and then performs provisioning on the tokens with the respective ESNs and the respective corresponding seed numbers, i.e. programming the respective ESN and the respective corresponding seed number into the token such that the token can generate one time password accordingly. Then, the token provider provides the tokens and the corresponding ESNs and seed numbers to a customer.

However, since the seed numbers are generated in the token provider, information of the ESNs and the corresponding seed numbers for a particular customer is stored in a database of the token provider. Once the database of the token provider is hacked, security of the particular customer is breached as well, i.e. the hacker can generate passwords with the stolen ESNs and the corresponding seed numbers. Thus, there is a need to improve over the prior art.

### SUMMARY OF THE INVENTION

It is therefore an objective of the present invention to provide a token provisioning method for a token provisioning system capable of generating electronic serial numbers (ESNs) and corresponding seed numbers of tokens at the customer side, and storing them only in a database of the customer, to enhance security.

The present invention discloses a token provisioning method for a token provisioning system. The token provisioning method includes steps of generating at least one encryption key at a customer side; generating a plurality of seed numbers corresponding to a plurality of electronic serial numbers (ESNs) at the customer side, respectively; encrypting the plurality of seed numbers and the plurality of corresponding ESNs with the at least one encryption key at the customer side; decrypting the plurality of seed numbers and the plurality of corresponding ESNs with the at least one encryption key; and programming a plurality of tokens with the plurality of seed numbers and the plurality of corresponding ESNs.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The FIGURE is a schematic diagram of a token provisioning process for a token provisioning system according to an embodiment of the present invention.

### DETAILED DESCRIPTION

Please refer to the FIGURE, which is a schematic diagram of a token provisioning process 10 for a token provisioning system according to an embodiment of the present invention. The token provisioning process 10 includes following steps:

Step 100: Start.

Step 102: Generate at least one encryption key at a customer side.

Step 104: Generate a plurality of seed numbers corresponding to a plurality of electronic serial numbers (ESNs) at the customer side, respectively.

Step 106: Encrypt the plurality of seed numbers and the plurality of corresponding ESNs with the at least one encryption key at the customer side.

Step 108: Decrypt the plurality of seed numbers and the plurality of corresponding ESNs with the at least one encryption key.

Step 110: Program a plurality of tokens with the plurality of seed numbers and the plurality of corresponding ESNs.

Step 112: End.

According to the token provisioning process 10, the present invention generates at least one encryption key and generates a plurality of seed numbers corresponding to a plurality of ESNs provided by a token provider (e.g. randomly or relevantly), respectively, and then encrypts the plurality of seed numbers and the plurality of corresponding ESNs with the at least one encryption key at a customer side. Afterwards, the present invention decrypts the plurality of seed numbers and the plurality of corresponding ESNs with the at least one encryption key, and then programs a plurality of tokens with the plurality of seed numbers and the plurality of corresponding ESNs at the customer side or the token provider side. Finally, the present invention stores the plurality of seed numbers and the plurality of corresponding ESNs in a database of the customer side.

Under such a situation, the plurality of seed numbers corresponding to the plurality of ESNs are generated at the customer side and then encrypted during transfer, and information of the plurality of ESNs and corresponding seed numbers for the tokens of the customer is only stored in the database of the customer side. Therefore, even if a database of the token provider is hacked, only information of ESNs for tokens of a particularly customer is leaked since there is no information of corresponding seed numbers in the database of the token provider. As a result, the present invention can enhance security by generating and only storing seed numbers in the customer side without leaving the seed numbers in the token provider.

Noticeably, the token provisioning system is not connected to Internet, and the at least one encryption key, the plurality of encrypted seed numbers and the plurality of corresponding encrypted ESNs are not transferred via Internet, such that the generated seed numbers, the at least one encryption key, the plurality of encrypted seed numbers and the plurality of corresponding encrypted ESNs are not hacked via Internet. Besides, the present invention can perform authorization with a plurality of respective passwords when utilizing the token provisioning system, i.e. each step of the token provisioning process 10, and the at least one encryption key, to further enhance security.

Specifically, after the present invention generate a first encryption key and a second encryption key at the customer side, wherein the first encryption key and the second encryption key can be received from an external system with high security such as a Hardware Security Modules (System). Then, the first encryption key and the second encryption key are stored in a secured device for transfer, wherein the secured device is preferably a write-only secured device requiring a password and capable of performing encryption internally for high security. Afterwards, each of the plurality of seed numbers and corresponding each of the plurality of ESNs with the first encryption key is encrypted in the secured device, to generate a plurality of encrypted seed numbers and a plurality of corresponding encrypted ESNs at the customer side, and then all of the plurality of encrypted seed numbers and all of the plurality of corresponding encrypted ESNs are encrypted with the second encryption key in the secured device, to generate an encryption file at the customer side.

On the other hand, after the encryption file and the first encryption key and the second encryption key stored in the secured device (or in respective secured devices) are transferred to a programming device for programming, e.g. in the customer side or in a token provider side, the encryption file is decrypted with the second encryption key in the secured device, and the plurality of encrypted seed numbers and the plurality of corresponding encrypted ESNs is decrypted with the first encryption key in the secured device. Under such a situation, the ESNs and the seed numbers are protected by two-layer encryption, i.e. for each seed number and all seed numbers, and encryption and decryption are performed in the secured device without the risk of leaking the first encryption key and the second encryption key. As a result, the present invention can further enhance security by performing two-layer encryption in the secured device.

Noticeably, the secured device is preferably a write-only secured device capable of performing encryption internally, but can be a smart card or a Universal Serial Bus (USB) storage device requiring a password with less security as well, i.e. the first encryption key and the second encryption key need to be read out for encryption and decryption.

Afterwards, other than perform authorization with a respective password for each step as described in the above, the present invention can further perform one time password (OTP) authentication before programming the plurality of tokens with the plurality of decrypted seed numbers and the plurality of corresponding decrypted ESNs, to enhance security. After programming, the present invention can verify the plurality of programmed tokens with at least one OTP value since the ESN and the seed number for each token is known. Then, the present invention can reprogram a portion of the plurality of tokens failed in verification, i.e. unsuccessfully programmed in the first round. Thus, all the tokens can be utilized.

Noticeably, the spirit of the present invention is to generate and only store seed numbers in the customer side without leaving the seed numbers in the token provider, and thus even if the database of the token provider is hacked, only information of the ESNs for tokens of a particularly customer is leaked since there is no information of corresponding seed numbers in the database of the token provider, to enhance security. Those skilled in the art should make modifications or alterations accordingly. For example, although the seed numbers and the ESNs are decrypted before programming, the decrypted seed numbers are erased and not stored in the programming device of the customer side or the token provider after programming.

However, for further enhancing security, other than utilizing the first encryption key and the second encryption key generated in the customer side for encryption, each of the plurality of raw seed numbers and corresponding each of the plurality of raw ESNs with a third encryption key, e.g. pre-stored in the secured device, is encrypted in the secured device, and is only decrypted with the third encryption key at a firmware of the programming device for programming the plurality of tokens before programming, or decrypted with the third encryption key before storing into the database of the customer side. As a result, the seed numbers and the ESNs are whole encrypted during transferring rather than in the form of raw data.

Noticeably, realizations of each step of the above token provisioning process 10 should be known by those skilled in the art. For example, each step of the token provisioning process 10 can be can be compiled as units into a program or other operating methods by instructions, parameters, variables, etc. of specific programming languages, and be executed by corresponding devices. The utilized devices are not limited to any form, e.g. software, hardware, firmware, and can be any device capable of executing the token provisioning process 10.

In the prior art, the seed numbers are generated in the token provider, and thus information of the ESNs and the corresponding seed numbers for a particular customer is stored in a database of the token provider. Once the database of the token provider is hacked, security of the particular customer is breached as well, i.e. the hacker can generate passwords with the stolen ESNs and the corresponding seed numbers. In comparison, the present invention generates and only stores seed numbers in the customer side without leaving the seed numbers in the token provider, and thus even if the database of the token provider is hacked, only information of the ESNs for tokens of a particularly customer is leaked since there is no information of corresponding seed numbers in the database of the token provider, so as to enhance security.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A token provisioning method for a token provisioning system, the token provisioning method comprising:
generating at least one encryption key at a customer side;
generating a plurality of seed numbers corresponding to a plurality of electronic serial numbers (ESNs) at the customer side, respectively;
encrypting the plurality of seed numbers and the plurality of corresponding ESNs with the at least one encryption key at the customer side;
decrypting the plurality of seed numbers and the plurality of corresponding ESNs with the at least one encryption key; and
programming a plurality of tokens with the plurality of seed numbers and the plurality of corresponding ESNs.

2. The token provisioning method of claim 1, wherein the step of decrypting the plurality of seed numbers and the plurality of corresponding ESNs with the at least one encryption key and programming the plurality of tokens with the plurality of seed numbers and the plurality of corresponding ESNs comprises:
decrypting the plurality of seed numbers and the plurality of corresponding ESNs with the at least one encryption key and programming the plurality of tokens with the plurality of seed numbers and the plurality of corresponding ESNs at the customer side.

3. The token provisioning method of claim 1, wherein the step of decrypting the plurality of seed numbers and the plurality of corresponding ESNs with the at least one encryption key and programming the plurality of tokens with the plurality of seed numbers and the plurality of corresponding ESNs comprises:
decrypting the plurality of seed numbers and the plurality of corresponding ESNs with the at least one encryption key and programming the plurality of tokens with the plurality of seed numbers and the plurality of corresponding ESNs at a token provider side.

4. The token provisioning method of claim 1 further comprising:
generating the plurality of seed numbers and the plurality of corresponding ESNs at the customer side, and storing them only in a database of the customer.

5. The token provisioning method of claim 1, wherein the token provisioning system is not connected to Internet, and the at least one encryption key, the plurality of encrypted seed numbers and the plurality of corresponding encrypted ESNs are not transferred via Internet.

6. The token provisioning method of claim 1 further comprising:
performing authorization with a plurality of respective passwords when utilizing the token provisioning system and the at least one encryption key.

7. The token provisioning method of claim 1, wherein the step of generating the at least one encryption key at the customer side comprises:
generating a first encryption key and a second encryption key at the customer side.

8. The token provisioning method of claim 1, wherein the step of generating the at least one encryption key at the customer side comprises:
receiving the at least one encryption key from an external system.

9. The token provisioning method of claim 1, wherein the step of generating the at least one encryption key at the customer side comprises:
generating the at least one encryption key and storing the at least one encryption key in a secured device at the customer side.

10. The token provisioning method of claim 9, wherein the step of encrypting the plurality of seed numbers and the plurality of corresponding ESNs with the at least one encryption key at the customer side comprises:
encrypting the plurality of seed numbers and the plurality of corresponding ESNs with the at least one encryption key in the secured device at the customer side.

11. The token provisioning method of claim 7, wherein the step of encrypting the plurality of seed numbers and the plurality of corresponding ESNs with the at least one encryption key at the customer side comprises:
encrypting each of the plurality of seed numbers and corresponding each of the plurality of ESNs with the first encryption key, to generate a plurality of encrypted seed numbers and a plurality of corresponding encrypted ESNs at the customer side; and
encrypting all of the plurality of encrypted seed numbers and all of the plurality of corresponding encrypted ESNs with the second encryption key at the customer side, to generate an encryption file at the customer side.

12. The token provisioning method of claim 9, wherein the step of decrypting the plurality of seed numbers and the plurality of corresponding ESNs with the at least one encryption key comprises:
decrypting the plurality of seed numbers and the plurality of corresponding ESNs with the at least one encryption key in the secured device.

13. The token provisioning method of claim 11, wherein the step of decrypting the plurality of seed numbers and the plurality of corresponding ESNs with the at least one encryption key comprises:
decrypting the encryption file with the second encryption key; and
decrypting the plurality of encrypted seed numbers and the plurality of corresponding encrypted ESNs with the first encryption key.

14. The token provisioning method of claim 11, wherein the step of programming the plurality of tokens with the plurality of seed numbers and the plurality of corresponding ESNs further comprises:
performing one time password (OTP) authentication before programming the plurality of tokens with the plurality of seed numbers and the plurality of corresponding ESNs.

15. The token provisioning method of claim 11, wherein the step of programming the plurality of tokens with the plurality of seed numbers and the plurality of corresponding ESNs further comprises:
verifying the plurality of programmed tokens with at least one OTP value.

16. The token provisioning method of claim 15, wherein the step of programming the plurality of tokens with the plurality of seed numbers and the plurality of corresponding ESNs further comprises:
reprogramming a portion of the plurality of tokens failed in verification.

17. The token provisioning method of claim 7, wherein the step of encrypting the plurality of seed numbers and the plurality of corresponding ESNs with the at least one encryption key at the customer side comprises:
encrypting each of the plurality of seed numbers and corresponding each of the plurality of ESNs with a third encryption key, respectively, to generate a plurality of first encrypted seed numbers and a plurality of corresponding first encrypted ESNs at the customer side;
encrypting each of the first encrypted plurality of seed numbers and corresponding each of the plurality of first encrypted ESNs with the first encryption key, respectively, to generate a plurality of second encrypted seed numbers and a plurality of corresponding second encrypted ESNs at the customer side; and
encrypting all of the plurality of second encrypted seed numbers and all of the plurality of second corresponding encrypted ESNs with the second encryption key at the customer side, to generate an encryption file.

18. The token provisioning method of claim 17, wherein the step of decrypting the plurality of seed numbers and the plurality of corresponding ESNs with the at least one encryption key comprises:
decrypting the encryption file with the second encryption key;
decrypting the plurality of second encrypted seed numbers and the plurality of corresponding second encrypted ESNs with the first encryption key; and
decrypting the plurality of first encrypted seed numbers and the plurality of corresponding first encrypted ESNs with the third encryption key at a firmware of a programming device for programming the plurality of tokens.
